(19) United States
(12) Patent Application Publication
(10) Pub. No.: US 2019/0246471 A1
(43) Pub. Date: Aug. 8, 2019

(54) LIGHT-EMITTING MODULE AND LIGHT-EMITTING DEVICE

(71) Applicant: SHARP KABUSHIKI KAISHA, Sakai City (JP)

(72) Inventor: TAKESHI TAKARADA, Sakai City (JP)

(21) Appl. No.: 16/241,879

(22) Filed: Jan. 7, 2019

(30) Foreign Application Priority Data
Feb. 8, 2018 (JP) 2018-020726

(51) Int. Cl. H05B 33/08; G02F 1/1335

(52) U.S. Cl. CPC H05B 33/0827; H05B 33/0815; H05B 33/0893; G02F 1/133603

(57) ABSTRACT

A light-emitting module includes a first LED, a second LED connected in parallel with the first LED, and a constant voltage circuit connected in series with the second LED and in parallel with the first LED. The constant voltage circuit maintains a voltage between one end and the other end at a constant voltage. The first LED and the second LED have the same VF characteristics.

### BACKGROUND OF THE INVENTION

### 1. Field of the Invention

The following disclosure relates to a light-emitting module and a light-emitting device, and more specifically, to a light-emitting module and a light-emitting device which use a light-emitting diode (LED).

### 2. Description of Related Art

The life of a liquid crystal display device for an industrial apparatus conventionally desired to be increased. Since the life of a liquid crystal panel itself is extremely long, the life of a liquid crystal display device is dependent on the life of a backlight. That increase in the life of a liquid crystal display device is realized by increasing the life of a backlight. Accordingly, a liquid crystal display device for an industrial apparatus often adopts a backlight that uses a long-life LED which is different from popular price LEDs used in mobile phones, general personal computers and the like. However, when an LED outside the popular price range is used, the cost tends to be increased.

Accordingly, in order to increase the life of a backlight, a light-emitting module having a configuration where a plurality of popular price LEDs which have the same characteristics are connected in parallel is sometimes adopted. For example, as shown in FIG. 10, an LED 90 is assumed which is lit at a brightness of 100 cd/m² when a forward voltage is 2.5 V and a current of 20 mA is caused to flow. When two LEDs 91, 92 having the same characteristics as the LED 90 are connected in parallel, a configuration as shown in FIG. 11 is obtained. When a current of 20 mA is supplied to a light-emitting module having the configuration shown in FIG. 11, a current of 10 mA flows through each of the two LEDs 91, 92, and the two LEDs 91, 92 are each lit at a brightness of 50 cd/m². The current which flows through the LED is thus reduced, and the life of the backlight is increased.

In relation to the present case, Japanese Laid-Open Patent Publication No. S59-4186 discloses an invention of a light-emitting diode device having a configuration where two LEDs having different rise characteristics (i.e., different VF characteristics) are connected in parallel. In the light-emitting diode device, when the life of a low-rise LED comes to an end, the LED to be lit is automatically switched to a high-rise LED. Japanese Laid-Open Patent Publication No. 2007-165161 discloses an invention of an LED illumination device provided with bypass means (which is realized by an LED, for example) that is provided in parallel to each LED in a configuration where a plurality of LEDs are connected in series. In the LED illumination device, even if one LED is broken (i.e., placed in an open state), reduction in the brightness as a whole is suppressed by the presence of the bypass means.

The configuration shown in FIG. 11 achieves a longer life than the configuration shown in FIG. 10. However, the configuration shown in FIG. 11 does not achieve a life that is close to twice the life achieved by the configuration shown in FIG. 10. This is because the life of the LED is dependent also on temperature, and a certain amount of heat is inevitably generated during operation.

According to the invention disclosed in Japanese Laid-Open Patent Publication No. S59-4186, cost is high because a plurality of types of LEDs with different rise characteristics have to be prepared. An increase in the cost is notable especially in a case where three or more LEDs are connected in parallel. Furthermore, according to the invention disclosed in Japanese Laid-Open Patent Publication No. 2007-165161, it is difficult to significantly increase the life, because all the LEDs which are connected in parallel are lit at all times.

### SUMMARY OF THE INVENTION

It is desired to greatly increase, at a low cost, the lives of a light-emitting module and a light-emitting device which use an LED.

A light-emitting module according to some aspects include

a first light-emitting diode;

a second light-emitting diode connected in parallel with the first light-emitting diode, and having same characteristics as the first light-emitting diode; and

a constant voltage circuit connected in series with the second light-emitting diode, and connected in parallel with the first light-emitting diode.

According to such a configuration, with respect to the light-emitting module including two light-emitting diodes (first light-emitting diode and second light-emitting diode) which are connected in parallel, when the life of the first light-emitting diode comes to an end, the light-emitting diode to be lit is automatically switched to the second light-emitting diode. Here, the second light-emitting diode is maintained in a non-lit state during a period when the first light-emitting diode is lit. Accordingly, the second light-emitting diode is hardly deteriorated during period when the first light-emitting diode is lit. Accordingly, a length of the life of the light-emitting module is a length corresponding to a sum of lengths of the lives of the two light-emitting diodes (first light-emitting diode and second light-emitting diode). In this manner, the life of the light-emitting module is significantly increased compared to a conventional case. In addition, because light-emitting diodes of a same type (light-emitting diodes of a same model number and same characteristics) may be adopted as the two light-emitting diodes, an increase in the life may be realized at a low cost by using popular price LEDs. As described above, the life of the light-emitting module, which uses the light-emitting diodes, may be significantly increased at a low cost. By using a backlight which uses such a light-emitting module, as a backlight of a liquid crystal display device, the life of the liquid crystal display device may be significantly increased.

These and other objects, features, modes, and advantageous effects of the present invention will be made further apparent from the appended drawings and the detailed description of the present invention given below.

### BRIEF DESCRIPTION OF THE DRAWINGS

FIG. 1 is a circuit diagram showing a configuration of a light-emitting module according to a first embodiment of the present invention.

FIG. 2 is a diagram for describing an operation of the light-emitting module at a time of normal driving (initial operation) according to the first embodiment.

FIG. 3 is a diagram for describing an operation of the light-emitting module after the life of a first LED comes to an end according to the first embodiment.

FIG. 4 is a diagram for describing an advantageous effect of the first embodiment.

FIG. 5 is a circuit diagram showing a configuration of a light-emitting module according to second embodiment of the present invention.

FIG. 6 is a diagram for describing an advantageous effect of the second embodiment.

FIG. 7 is a circuit diagram showing a configuration of a light-emitting device according to a third embodiment of the present invention.

FIG. 8 is a circuit diagram showing a configuration of a light-emitting device according to a fourth embodiment of the present invention.

FIG. 9 is a circuit diagram showing a configuration of a light-emitting device according to an example modification of the fourth embodiment.

FIG. 10 is a diagram for describing a conventional art.

FIG. 11 is a diagram for describing a conventional art.

### DETAILED DESCRIPTION OF PREFERRED EMBODIMENTS

Hereinafter, embodiments of the present invention will be described with reference to the drawings.

### 1. First Embodiment

<1.1 Configuration>

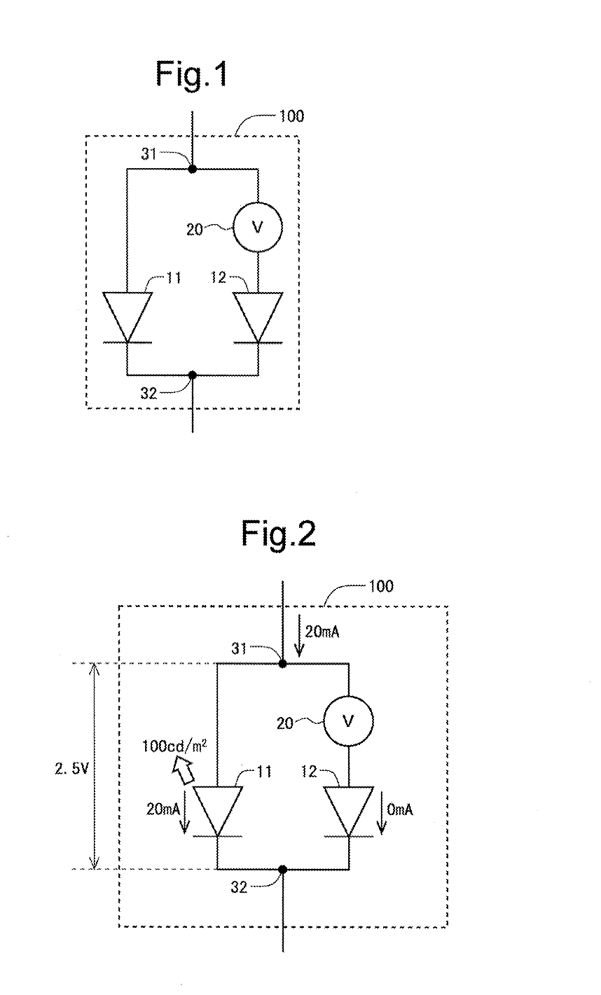

FIG. 1 is a circuit diagram showing a configuration of a light-emitting module 100 according to a first embodiment of the present invention. The light-emitting module 100 includes two LEDs (a first LED 11 and a second LED 12), and a constant voltage circuit 20. More specifically, the light-emitting module 100 includes the first LED 11, the second LED 12 connected in parallel with the first LED 11, and the constant voltage circuit 20 connected in series with the second LED 12 and in parallel with the first LED 11. In this manner, the constant voltage circuit 20 is connected in series only with one of the two LEDs.

As can be seen in FIG. 1, an anode of the first LED 11 and one end of the constant voltage circuit 20 are connected, an anode of the second LED 12 and another end of the constant voltage circuit 20 are connected, and a cathode of the first LED 11 and a cathode of the second LED 12 are connected. The constant voltage circuit 20 maintains a voltage between one end and the other end at a constant voltage by a known configuration that uses a zener diode, for example. The first LED 11 and the second LED 12 have the same VF characteristics. As for the first LED 11 and the second LED 12, though not particularly limited, popular price LEDs may be adopted.

Here, it is assumed that the constant voltage circuit 20 maintains the voltage between one end and the other end at 0.5 (in other words, the constant voltage circuit 20 maintains a state where a voltage at one end is higher than a voltage at the other end by 0.5 V). Moreover, it is also assumed that a forward voltage of the first LED 11 and the second LED 12 is 2.5 V, and a constant current of 20 mA is supplied to the light-emitting module 100. However, the specific values are not particularly limited.

Although the constant voltage circuit 20 is provided on the anode side of the second LED 12 in the present embodiment, the same advantageous effect is obtained by adopting a configuration where the constant voltage circuit 20 is provided on the cathode side of the second LED 12 (that is, a configuration where the constant voltage circuit 20 is provided between the second LED 12 and a node 32).

<1.2 Operation>

Next, an operation of the light-emitting module 100 will be described. First, at the time of normal driving (at the time of initial operation), as shown in FIG. 2, when a voltage between a node 31 and the node 32 reaches 2.5 V, a current of 20 mA flows through the first LED 11, and the first LED 11 is lit at a brightness of 100 cd/m². At this time, since a constant voltage of 0.5 V is generated by the constant voltage circuit 20 as described above, a voltage between the anode and the cathode of the second LED 12 is 2.0 V. The voltage (2.0 V) between the anode and the cathode of the second LED 12 is thus smaller than the forward voltage (2.5 V), and therefore, the second LED 12 is not lit.

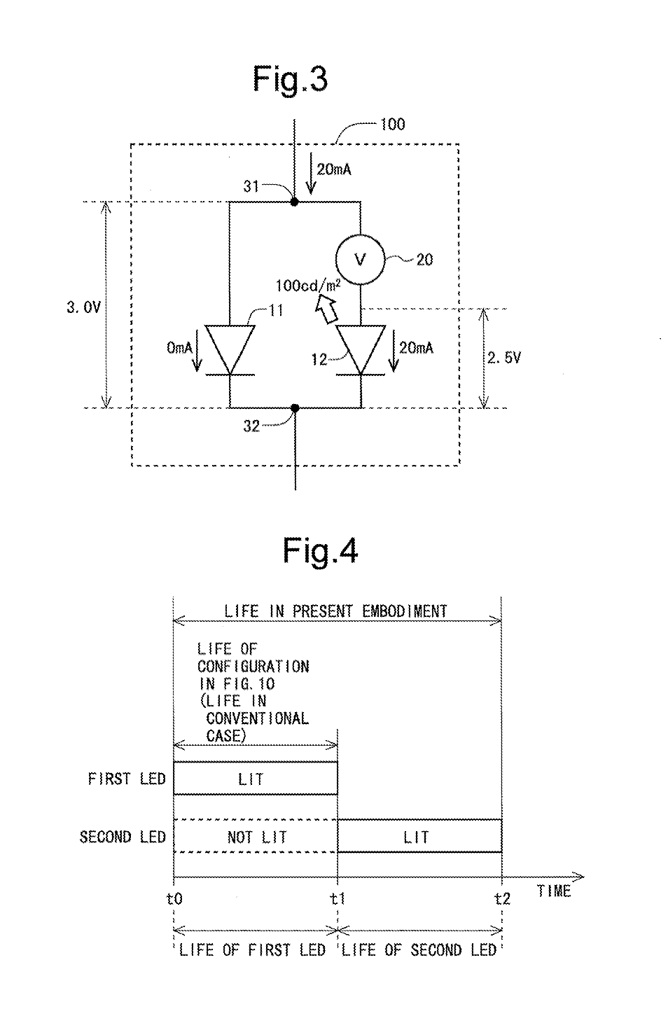

Then, when the life of the first LED 11 comes to an (when the first LED 11 reaches an open state), the current stops flowing through the first LED 11, and the voltage between the node 31 and the node 32 is increased. When the voltage between the node 31 and the node 32 reaches 3.0 V, the voltage between the anode and the cathode of the second LED 12 becomes 2.5 V, as shown in FIG. 3. A current of 20 mA thereby flows through the second LED 12, and the second LED 12 is lit at a brightness of 100 cd m². The voltage between the node 31 and the node 32 is maintained at 3.0 V while the second LED 12 is lit.

<1.3 Advantageous Effects>

According to the present embodiment, with respect to the light-emitting module 100 including two LEDs (the first LED 11 and the second LED 12) which are connected in parallel, when the life of the first LED 11 comes to an end, the LED to be lit is automatically switched to the second LED 12. Here, the second LED 12 is maintained in a non-lit state during a period when the first LED 11 is lit. Accordingly, the second LED 12 is hardly deteriorated during a period when the first LED 11 is lit. Accordingly, as shown in FIG. 4, a length of the life of the light-emitting module 100 is a length corresponding to a sum of lengths of the lives of the two LEDs (the first LED 11 and the second LED 12). In this manner, the life of the light-emitting module 100 is significantly increased compared to a conventional case. In addition, because LEDs of a same type (LEDs of a same model number and same characteristics) may be adopted as the two LEDs, an increase in the life may be realized at a low cost by using popular price LEDs. As described above, according to the present embodiment, the life of the light-emitting module, which uses the LEDs, may be significantly increased at a low cost. By using a backlight which uses such a light-emitting module, as a backlight of a liquid crystal display device, the life of the liquid crystal display device may be significantly increased.

### 2. Second Embodiment

<2.1 Configuration>

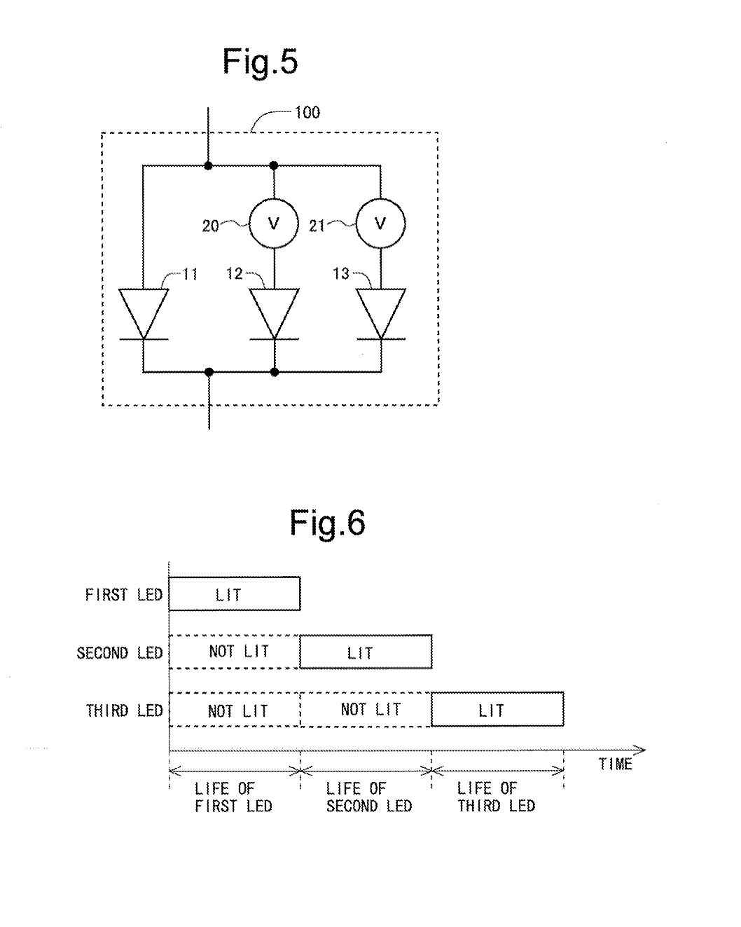

FIG. 5 is a circuit diagram showing a configuration of a light-emitting module 100 according to a second embodiment of the present invention. The light-emitting module 100 includes three LEDs (a first LED 11, a second LED 12, and a third LED 13), and two constant voltage circuits 20, 21. As can be seen in FIG. 5, the constant voltage circuit 20 and the second LED 12 are connected in series, and the constant voltage circuit 21 and the third LED 13 are connected in series. When a set of circuit portions including a constant voltage circuit and an LED which are connected in series is defined as a “sub-lighting circuit” for the sake of convenience, the light-emitting module 100 according to the present embodiment includes two sub-lighting circuits which are connected in parallel. The constant voltage circuits included in the two sub-lighting circuits generate constant voltages at different levels from each other. That is, the constant voltage circuit 20 and the constant voltage circuit 21 are configured to generate constant voltages at different levels from each other. For example, the constant voltage circuit 20 maintains a voltage between one end and another end at 0.5 V, and the constant voltage circuit 21 maintains a voltage between one end and another end at 1.0 V. It should be noted that the constant voltage circuit 20 and the constant voltage circuit 21 may be provided on the cathode side of the second LED 12 and the third LED 13, respectively.

<2.2 Operation and Advantageous Effects>

According to the configuration described above, as shown in FIG. 6, first, the first LED 11 is placed in a lit state, and the second LED 12 is placed in the lit state when the life of the first LED 11 comes to an end, and the third LED 13 is placed in the lit state when the life of the second LED 12 comes to an end. Accordingly, a length of the life of the light-emitting module 100 is a length corresponding to a sum of lengths of the lives of the three LEDs (the first LED 11, the second LED 12, and the third LED 13). The life of the light-emitting module may thus be further increased than that in the first embodiment. Moreover, by adopting a configuration where three or more sub-lighting circuits mentioned above are connected in parallel, the life of the light-emitting module may be further increased.

### 3. Third Embodiment

<3.1 Configuration>

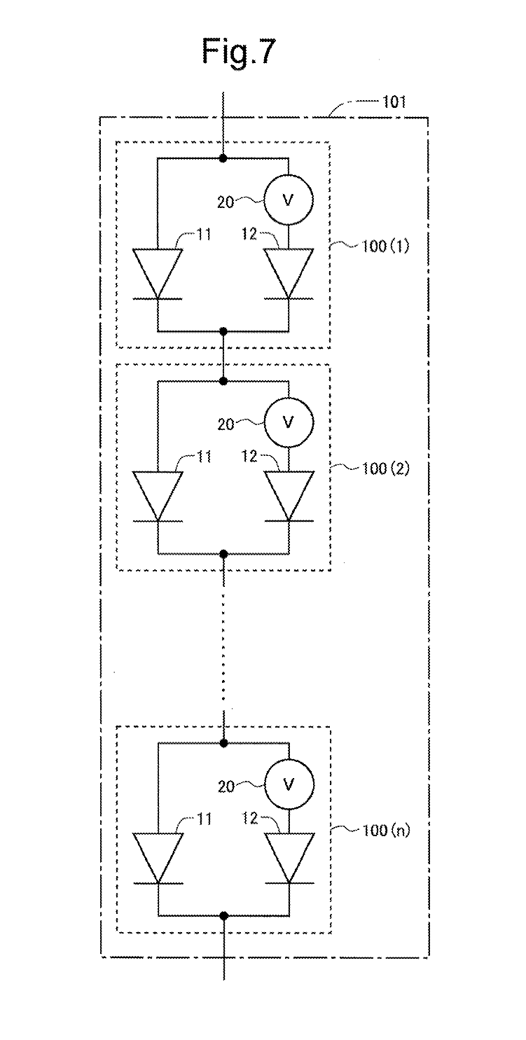

FIG. 7 is a circuit diagram showing a configuration of a light-emitting device 101 according to a third embodiment of the present invention. The configuration of the light-emitting device 101 is a configuration where n light-emitting modules 100 according to the first embodiment (see FIG. 1) are connected in series. It should be noted that a configuration where n light-emitting modules 100 according to the second embodiment (see FIG. 5) are connected in series may also be adopted. Each constant voltage circuit 20 may be provided on the cathode side of the second LED 12.

<3.2 Operation and Advantageous Effects>

According to the configuration described above, with respect to each light-emitting module 100 constituting the light-emitting device 101, first, the first LED 11 is placed in a lit state, and the second LED 12 is placed in the lit state when the life of the first LED 11 comes to an end. If all the LEDs (the first LEDs 11 and the second LEDs 12) have the same characteristics, when focusing on a long term, the lives of the first LEDs 11 of all the light-emitting modules 100 come to an end approximately at the same time. Moreover, when focusing on a long term, the second LEDs 12 of all the light-emitting modules 100 are lit for approximately the same length of time. Accordingly, a length of the Life of the light-emitting device 101 is a length corresponding approximately to a sum of a length of the life of the first LED 11 and a length of the life of the second LED 12. In this manner, the life of the light-emitting device 101 is significantly increased compared to a conventional case. Further, as in the first embodiment, the life can be increased at a low cost by using popular price LEDs. As described above, according to the present embodiment, the life of the light-emitting device, which uses the LEDs, may be significantly increased at a low cost. By using a backlight which uses such a light-emitting device, as a backlight of a liquid crystal display device, the life of the liquid crystal display device may be significantly increased.

### 4. Fourth Embodiment

<4.1 Configuration>

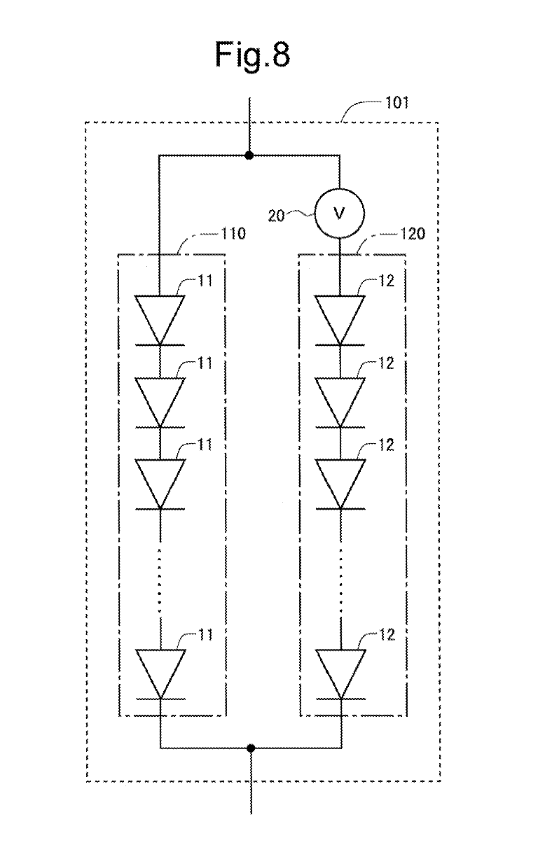

FIG. 8 is a circuit diagram showing a configuration of a light-emitting device 101 according to a fourth embodiment of the present invention. The light-emitting device 101 includes two LED arrays (a first LED array 110 and a second LED array 120), and a constant voltage circuit 20. More specifically, the light-emitting device 101 includes a first LED array 110, a second LED array 120 connected in parallel with the first LED array 110, and a constant voltage circuit 20 connected in series with the second LED array 120 and in parallel with the first LED array 110. In this manner, the constant voltage circuit 20 is connected in series only with one of the two LED arrays. It should be noted that the constant voltage circuit 20 may alternatively be provided on a cathode side of an LED 12 on a most downstream side in the second LED array 120.

The first LED array 110 includes a plurality of LEDs 11 which are connected in series (each of the plurality of LEDs 11 is referred to as a “first LED” for the sake of convenience). The second LED array 120 includes a plurality of LEDs 12 which are connected in series (each of the plurality of LEDs 12 will be referred to as a “second LED” for the sake of convenience). The number of the first LEDs 11 and the number of the second LEDs 12 are the same, and all the LEDs (the first LEDs 11 and the second LEDs 12) have the same VF characteristics.

<4.2 Operation and Advantageous Effects>

According to the configuration described above, first, the plurality of first LEDs 11 constituting the first LED array 110 are placed in a lit state. Then, when the life of one of the plurality of first LEDs 11 comes to an end, a current stops flowing through the first LED array 110. Then, a voltage at one end of the constant voltage circuit 20 is increased. As a result, a current flows through the second LED array 120, and the plurality of second LEDs 12 constituting the second LED array 120 are placed in the lit state. Accordingly, a length of the life of the light-emitting device 101 is a length corresponding to a sum of lengths of the lives of the two LED arrays (the first LED array 110 and the second LED array 120). In this manner, the life of the light-emitting device 101 is significantly increased compared to a conventional case. Moreover, as in the first embodiment, the life can be increased at a low cost by using popular price LEDs. As described above, also according to the present embodiment, the life of the light-emitting device, which uses the LEDs, may be significantly increased at a low cost.

<4.3 Example Modification>

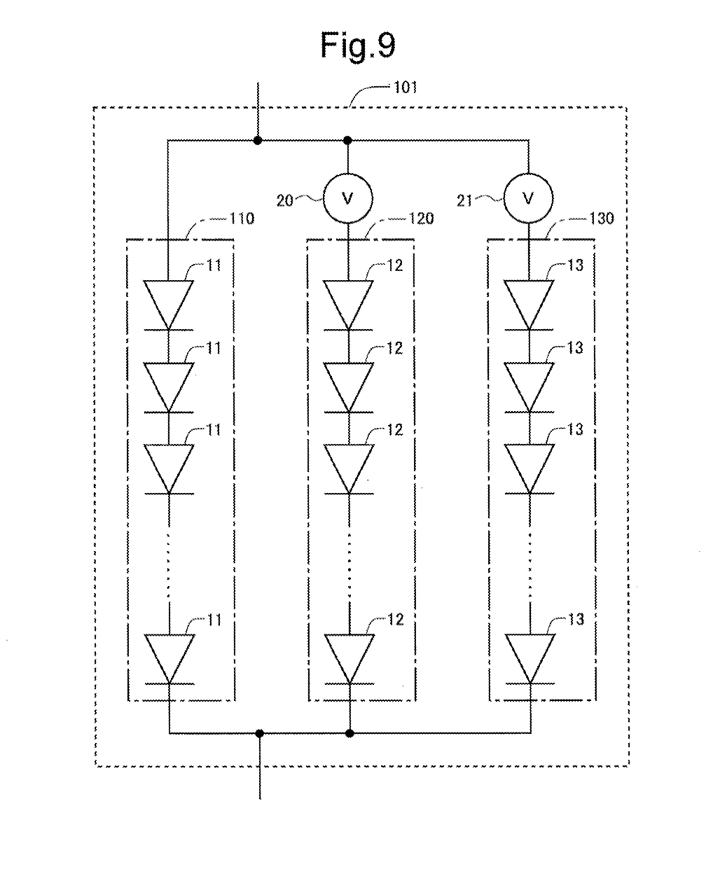

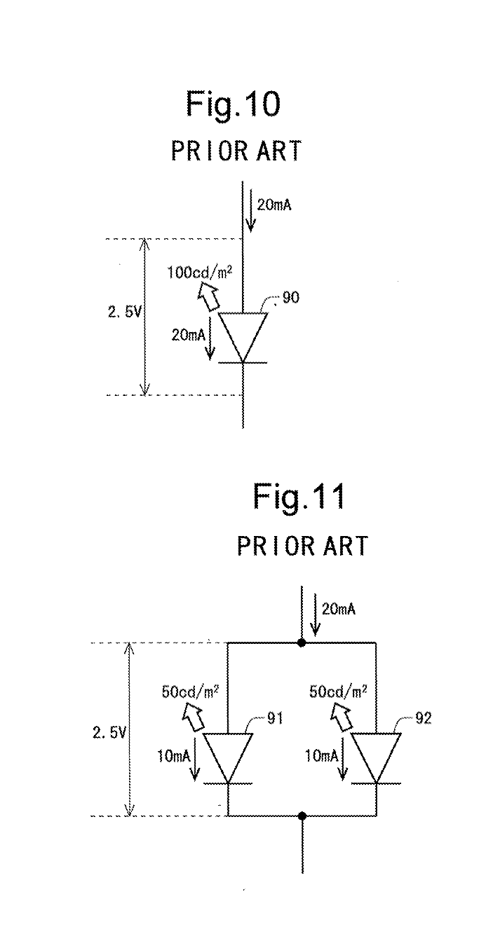

FIG. 9 is a circuit diagram showing a configuration of a light-emitting device 101 according to an example modification of the present embodiment. As in the second embodiment, a configuration where a plurality of sub-lighting circuits, each including an LED array and a constant voltage circuit, are connected in parallel as shown in FIG. 9 may also be adopted. By adopting such a configuration, the life of the light-emitting device may be further increased. It should be noted that the constant voltage circuit 20 and the constant voltage circuit 21 may alternatively be provided on a cathode side of the LED 12 on a most downstream side in the second LED array 120 and the LED 13 on a most downstream side in the third LED array 130, respectively.

The present invention is described above in detail, but the description is illustrative in all aspects and is not restrictive. Numerous other changes and modifications are conceivable without departing from the scope of the present invention.

The present application claims priority to Japanese Patent Application No. 2018-20726 filed on Feb. 8, 2018 and entitled “light-emitting module and light-emitting device”, the entire contents of which are incorporated herein by reference.

What is claimed is:

1. A light-emitting module comprising:
a first light-emitting diode;
a second light-emitting diode connected in parallel with the first light-emitting diode, and having same characteristics as the first light-emitting diode; and
a constant voltage circuit connected in series with the second light-emitting diode, and connected in parallel with the first light-emitting diode.

2. The light-emitting module according to claim 1, wherein
a plurality of sub-lighting circuits, each including the second light-emitting diode and the constant voltage circuit, are connected in parallel, and
the constant voltage circuits included in the plurality of sub-lighting circuits generate constant voltages at different levels from each other.

3. The light-emitting module according to claim 1, wherein
an anode of the first light-emitting diode and one end of the constant voltage circuit are connected,
an anode of the second light-emitting diode and an other end of the constant voltage circuit are connected,
a cathode of the first light-emitting diode and a cathode of the second light-emitting diode are connected, and
the constant voltage circuit maintains a state where a voltage at the one end is higher than a voltage at the other end by a certain amount.

4. A light-emitting device, wherein a plurality of light-emitting modules according to claim 1 are connected in series.

5. A light-emitting device comprising:
a first light-emitting diode array including a plurality of light-emitting diodes connected in series;
a second light-emitting diode array including a plurality of light-emitting diodes, and connected in parallel with the first light-emitting diode array; and
a constant voltage circuit connected in series with the second light-emitting diode array, and connected in parallel with the first light-emitting diode array,
wherein
all the light-emitting diodes included in the first light-emitting diode array and the second light-emitting diode array have same characteristics.

6. The light-emitting device according to claim 5, wherein
a plurality of sub-lighting circuits, each including the second light-emitting diode array and the constant voltage circuit, are connected in parallel, and
the constant voltage circuits included in the plurality of sub-lighting circuits generate constant voltages at different levels from each other.
